(19) United States
(12) Patent Application Publication
(10) Pub. No.: US 2007/0140357 A1
(43) Pub. Date: Jun. 21, 2007

(54) Method and apparatus for treating a video signal

(75) Inventor: Clay D. Montgomery, Plano, TX (US)

Correspondence Address: TEXAS INSTRUMENTS INCORPORATED, P O BOX 655474, M/S 3999, DALLAS, TX, 75265, US

(73) Assignee: Texas Instruments Incorporated

(21) Appl. No.: 11/603,505

(22) Filed: Nov. 22, 2006

Related U.S. Application Data
(60) Provisional application No. 60/751,157, filed on Dec. 16, 2005.

(51) Int. Cl. H04N 7/12; H04N 5/253

(52) U.S. Cl. 375/240.26; 348/97

(57) ABSTRACT

A method for treating a video signal including a plurality of consecutive video fields; at least some video fields of the plurality of video fields contributing to a plurality of substantially successively occurring motion sums; includes: (a) Effecting successive comparison of selected of the motion sums with at least one motion sum threshold in a predetermined cycle. The motion sum threshold is related with at least one earlier-occurring motion sum. The predetermined cycle establishes the successive comparison for evaluating whether the selected motion sums occur in a pattern characteristic of film mode content. (b) Treating the video signal as containing film mode content so long as the successive comparison indicates film mode content. (c) Treating the video signal as not containing the film mode content when a predetermined number of the successive comparisons indicate no film mode content.

This application claims benefit of prior filed copending Provisional Patent Application Ser. No. 60/751,157, filed Dec. 16, 2005.

### BACKGROUND OF THE INVENTION

The present invention is directed to video signals, and especially to video signals containing a portion of their content in film mode having been subjected to a pull-down treatment, and containing a portion of their content in a video mode not having been subjected to a pull-down treatment.

Interlaced NTSC (National Television Standards Committee) television is based upon an interlaced 60 frames per second. Televisions create images by scanning lines on the screen face, left-to-right and top-to-bottom to produce a picture on the entire screen. The images that make up the picture are alternating interlaced fields—one field consists of odd lines (1, 3, 5, . . . through 525) and the other field consists of even lines (2, 4, 6, . . . through 524). As a result only half of the picture is drawn every 1/60 second. Each field is a snapshot in time, and when an object in a picture is not in motion, the pictures from frame to frame complement each other to present a crisp, clear image. However, when an object In a picture moves, the images from frame to frame no longer complement each other and there are interlacing artifacts, such as “combing” (manifested in jagged vertical edges) and “line twitter” (manifested in horizontal displacement of a portion of the image).

Since the time of Thomas Alva Edison, motion picture photography has been based upon 24 frames per second. Because 60 (i.e., 60 video fields per second) is not an even multiple of 24 (24 motion picture frames per second), one cannot directly apply motion picture photography to a video format. A solution has been developed in industry to make 4 film frames (i.e., 6 times 4=24) fit substantially evenly across 10 video fields (i.e., 6 times 10=60). The solution is known as 3:2 pull-down and is described in detail herein in connection with FIG. 1.

However, in the case of newer progressive-scan television formats there is still a problem. In a progressive-scan format, each scan of the display is a complete picture including all scan lines from top to bottom. A single progressive scan is referred to as a video frame (as opposed to a video field; interlaced display). There are 60 frames per second displayed in, by way of example and not by way of limitation, a high definition television (HDTV). Progressive displays exhibit none of the artifacts manifested by interlaced displays. However, in video signals that have originated from a film format (sometimes referred to as having film content), there is a problem if the video signal is displayed without first reversing any 3:2 pull-down treatment to which the video signal may have been subjected. Video signals that have originated partly from film and partly from video are particularly problematic. One may readily observe discontinuities in the display of such videos as content changes from film content (or film mode) to video content (or video mode) or from video content to film content.

To be able to compensate for mode changes in a video signal, one must be able to recognize when a video signal changes from film mode to video mode or changes from video mode to film mode. A prior art approach developed for recognizing such mode changes is described herein in connection with FIG. 1. The prior art approach described in connection with FIG. 1 is useful when ascertaining a change from a video mode to a film mode. However, the inventor has discovered that the prior art approach described in connection with FIG. 1 is not reliable in detecting an end to a film mode—that is an end to application of a 3:2 pull-down treatment—in a video signal. The unreliability occurs at least in part because the prior art detection algorithm compares a portion of the video signal field-to-field (e.g., luma data; black-and-white video data) with a threshold value to ascertain change indicating cessation of 3:2 pull-down treatment of the signal being evaluated. A problem is that there may be noise present in the signal being evaluated, and noise may give false values that are used in the field-to-field comparisons. Noise may be injected into the evaluated signal by conversion processes (i.e., from film to video; 3:2 pull-down treatment), from transmission operations via cable or satellite, or from other noise sources. Further, the prior art approach uses a single threshold for comparisons to ascertain change indicating cessation of 3:2 pull-down treatment. Noise may look like a change, but is not really a change that should indicate a cessation of 3:2 pull-down treatment. Noise can give false results using the prior art approach to detecting an end of 3:2 pull-down treated signals.

There is a need for a method and apparatus for treating a video signal that can reliably detect cessation of 3:2 pull-down treatment of a video signal.

There is a need for a method and apparatus that reliably indicates when a video signal stream changes from a film mode.

Such a reliable indication is useful for determining when one may stop reversing 3:2 pull-down treatment of the signal when displaying the signal in a progressive scan mode.

### SUMMARY OF THE INVENTION

A method for treating a video signal including a plurality of consecutive video fields; at least some video fields of the plurality of video fields contributing to a plurality of substantially successively occurring motion sums; includes: (a) Effecting successive comparison of selected of the motion sums with at least one motion sum threshold in a predetermined cycle. The motion sum threshold is related with at least one earlier-occurring motion sum. The predetermined cycle establishes the successive comparison for evaluating whether the selected motion sums occur in a pattern characteristic of film mode content. (b) Treating the video signal as containing film mode content so long as the successive comparison indicates film mode content. (c) Treating the video signal as not containing the film mode content when a predetermined number of the successive comparisons indicate no film mode content.

An apparatus for treating a video signal; the video signal including a plurality of consecutive video fields; first selected video fields of the plurality of video fields including film mode content; second selected video fields of the plurality of video fields including non-film mode content; at least some video fields of the plurality of video fields contributing to a plurality of substantially successively occurring motion sums; includes: (a) a comparing unit for effecting successive comparison of selected motion sums of the plurality of motion sums with at least one motion sum threshold in a predetermined cycle; the at least one motion sum threshold having a value related with at least one earlier-occurring motion sum; the predetermined cycle establishing the successive comparison for evaluating whether the selected motion sums occur in a pattern characteristic of the film mode content; and (b) a treating unit for coupled with the comparing unit; the treating unit treating the video signal as containing the film mode content so long as the successive comparison indicates the video signal contains the film mode content; the treating unit treating the video signal as not containing the film mode content when a predetermined number of the successive comparisons indicate the video signal does not contain the film mode content.

It is, therefore, an object of the present invention to provide a method and apparatus for treating a video signal that can reliably detect cessation of 3:2 pull-down treatment of a video signal.

It is a further object of the present invention to provide a method and apparatus that reliably indicates when a video signal stream changes from a film mode.

Further objects and features of the present invention will be apparent from the following specification and claims when considered in connection with the accompanying drawings, in which like elements are labeled using like reference numerals in the various figures, illustrating the preferred embodiments of the invention.

### BRIEF DESCRIPTION OF THE DRAWINGS

FIG. 1 is a schematic diagram illustrating the process of 3:2 pull-down conversion of motion picture film images to a video format.

FIG. 2 is a schematic diagram of the state machine preferred for use in practicing the method of the present invention.

FIG. 3 is a schematic diagram of the hysteresis counter unit preferred for use in practicing the method of the present invention.

FIG. 4 is an electrical schematic diagram of a preferred embodiment of the apparatus of the present invention.

### DETAILED DESCRIPTION OF THE PREFERRED EMBODIMENT

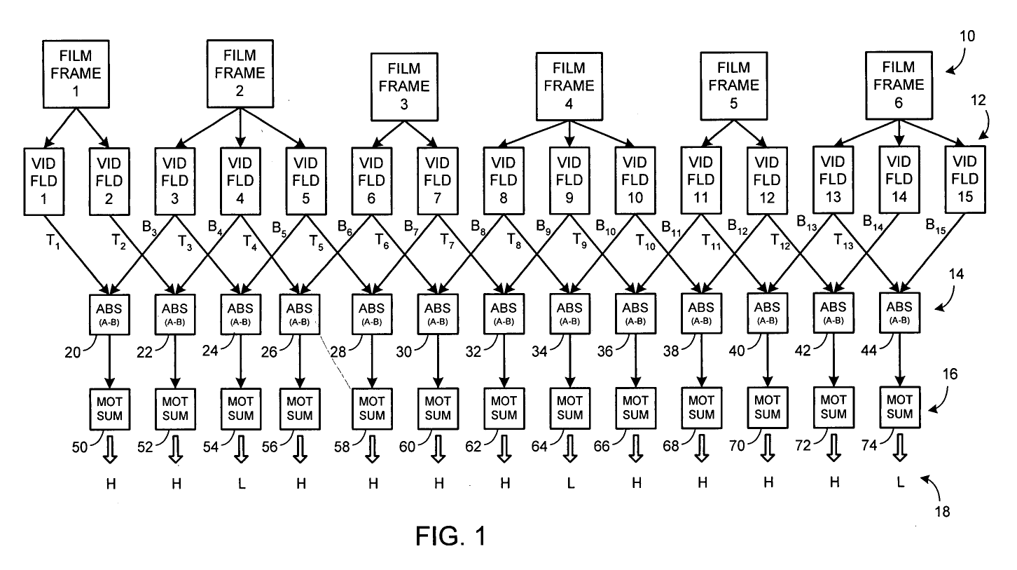

FIG. 1 is a schematic diagram illustrating the process of 3:2 pull-down conversion of motion picture film images to a video format. In FIG. 1, a first row 10 of frames contains a consecutively occurring series of film frames: Film Frame 1, Film Frame 2, Film Frame 3, Film Frame 4, Film Frame 5, Film Frame 6. Of course, more film frames may follow Film Frame 6, but in order to simplify FIG. 1, only six film frames are illustrated. Film Frames 1-6 are recorded and are presented for display at a speed of 24 frames per second.

As mentioned earlier herein, video signals may be recorded at a speed of 60 fields per second. A process known in the industry as 3:2 pull-down is employed to convert film recordings for compatible display with video equipment. Accordingly, in FIG. 1 a stream of video fields (VID FLD) is illustrated in a second row 12: VID FLD1 through VID FLD 15. Of course, more video fields may follow VID FLD 15, but in order to simplify FIG. 1, only fifteen video fields are illustrated. VID FLDs 1-15 are recorded and are presented for display at a speed of 60 fields per second.

In a 3:2 pull-down conversion, alternating film frames are employed in either two consecutive video fields or are employed in three consecutive video fields. Thus, Film Frame 1 is presented or employed in VID FLD 1 and VID FLD 2. Film Frame 2 is presented or employed in VID FLD 3, VID FLD 4 and VID FLD 5. Film Frame 3 is presented or employed in VID FLD 6 and VID FLD 7. Film Frame 4 is presented or employed in VID FLD 8, VID FLD 9 and VID FLD 10. Film Frame 5 is presented or employed in VID FLD 11 and VID FLD 12. Film Frame 6 is presented or employed in VID FLD 13, VID FLD 14 and VID FLD 15.

As mentioned earlier herein, video fields (VID FLDs) are arranged for interlaced NTSC (National Television Standards Committee) television display presenting an interlaced 60 frames (fields) per second. Televisions create images by scanning lines on the screen face, left-to-right and top-to-bottom to produce a picture on the entire screen. The images that make up the picture are alternating interlaced fields—one field consists of odd lines (1, 3, 5, . . . through 525) and the other field consists of even lines (2, 4, 6, . . . through 524). A stream of interlaced video fields (ABS) is illustrated in a third row 14. The annotation ABS indicates that each interlaced video field includes a top row video field (A) and a bottom row video field (B) for use in an interlaced NTSC video display. Thus, an interlaced video field ABS 20 receives top-row (A) video data T₁ from video field VID FLD 1 and receives bottom-row (B) video data B₃ from video field VID FLD 3. An interlaced video field ABS 22 receives top-row (A) video data T₂ from video field VID FLD 2 and receives bottom-row (B) video data B₄ from video field VID FLD 4. An interlaced video field ABS 24 receives top-row (A) video data T₃ from video field VID FLD 3 and receives bottom-row (B) video data B₅ from video field VID FLD 5. An interlaced video field ABS 26 receives top-row (A) video data T₄ from video field VID FLD 4 and receives bottom-row (B) video data B₆ from video field VID FLD 6. An interlaced video field ABS 28 receives top-row (A) video data T₅ from video field VID FLD 5 and receives bottom-row (B) video data B₇ from video field VID FLD 7. An interlaced video field ABS 30 receives top-row (A) video data T₆ from video field VID FLD 6 and receives bottom-row (B) video data B₈ from video field VID FLD 8. An interlaced video field ABS 32 receives top-row (A) video data T₇ from video field VID FLD 7 and receives bottom-row (B) video data B₉ from video field VID FLD 9. An interlaced video field ABS 34 receives top-row (A) video data T₈ from video field VID FLD 8 and receives bottom-row (B) video data B₁₀ from video field VID FLD 10. An interlaced video field ABS 36 receives top-row (A) video data T₉ from video field VID FLD 9 and receives bottom-row (B) video data B₁₁ from video field VID FLD 11. An interlaced video field ABS 38 receives top-row (A) video data T₁₀ from video field VID FLD 10 and receives bottom-row (B) video data B₁₂ from video field VID FLD 12. An interlaced video field ABS 40 receives top-row (A) video data T₁₁ from video field VID FLD 11 and receives bottom-row (B) video data B₁₃ from video field VID FLD 13. An interlaced video field ABS 42 receives top-row (A) video data T₁₂ from video field VID FLD 12 and receives bottom-row (B) video data B₁₄ from video field VID FLD 14. An interlaced video field ABS 44 receives top-row (A) video data T₁₃ from video field VID FLD 13 and receives bottom-row (B) video data B₁₅ from video field VID FLD 15.

Motion sums of the data contained in interlaced video fields (ABS 20-44) are illustrated in a fourth row 14. In the representative situation illustrated in FIG. 1, motion sums are calculated by the algebraic sum (A-B) for each respective interlaced video field ABS 20-44. The motion sums exhibit a cadence or repeating pattern of high values and low values, as indicated in a fifth row 18. Thus, a motion sum 50 related to interlaced video field ABS 20 is a high value. A motion sum 52 related to interlaced video field ABS 22 is a high value. A motion sum 54 related to interlaced video field ABS 24 is a low value. A motion sum 56 related to interlaced video field ABS 26 is a high value. A motion sum 58 related to interlaced video field ABS 28 is a high value. A motion sum 60 related to interlaced video field ABS 30 is a high value. A motion sum 62 related to interlaced video field ABS 32 is a high value. A motion sum 64 related to interlaced video field ABS 34 is a low value. A motion sum 66 related to interlaced video field ABS 36 is a high value. A motion sum 68 related to interlaced video field ABS 38 is a high value. A motion sum 70 related to interlaced video field ABS 40 is a high value. A motion sum 72 related to interlaced video field ABS 22 is a high value. A motion sum 74 related to interlaced video field ABS 44 is a low value.

Low motion sums 54, 64, 74 are assured to be low with respect to other motion sums because one may note that motion sums 54, 64, 74 involve subtracting identical elements from themselves. Motion sum 54 involves subtracting data originating from Film Frame 2. Motion sum 64 involves subtracting data originating from Film Frame 4. Motion sum 74 involves subtracting data originating from Film Frame 6.

One may also note the cadence or repeating pattern of motion sums in row 18 HIGH, HIGH, HIGH, HIGH, LOW (hereinafter sometimes referred to as “HHHHL Cadence”). It is this cadence that is employed to detect the presence of film mode content (i.e., content of the video signal being evaluated that originated from 24 frames per second film).

Treatment of film content with a 3:2 pull-down treatment is a good solution when film-sourced content is to be shown on an interlaced display, However, such 3:2 pull-down treatment is problematic when combined with deinterlacing techniques that are used for showing video signals on a progressively scanned display. The problems are related to temporal (i.e., time-related) displacement of video fields that occurs when the fields are recombined into progressive frames. The problem is manifested in that objects that are moving in the displayed image appear to have a tearing or “feathering” effect along their edges.

Therefore, when deinterlacing a video stream, it is important to know whether the content is film-mode content that has been subjected to 3:2 pull-down treatment. If the content is film-mode content and the video signal is to be displayed on a progressively scanned display, better display quality can be achieved by reversing the 3:2 pull-down treatment before deinterlacing the video signal. Reverse 3:2 pull-down treatment essentially reorders the video fields back into their original (progressive) order as the images occurred on the original film. Such reverse 3:2 pull-down treatment may be effected in two steps: (1) Detecting that the video stream being evaluated has been converted using a 3:2 pull-down treatment (film-mode), and (2) if film-mode is detected, reorder the fields back to their original order (reverse 3:2 pull-down treatment).

Prior art techniques compare motion sums (row 18; FIG. 1) with a predetermined threshold to determine (1) when film mode content begins, and (2) when film mode ends in a video stream. Comparisons with a threshold are made to ascertain changes from field-to-field in the displayed video signal so as to ascertain the HHHHL Cadence that is characteristic of film content in a video signal subjected to 3:2 pull-down treatment. Prior art techniques compare each motion sum with a static threshold. If the motion sum is less than the threshold, the motion sum is deemed “small” or “LOW”, otherwise the motion sum is deemed “large” or “HIGH”.

The inventor has discovered that the prior art technique algorithm is not reliable and may be “fooled” when seeking to ascertain when a video signal stream containing film-mode content changes from film-mode content. The unreliability occurs at least in part because the prior art detection algorithm compares a portion of the video signal field-to-field with a threshold value to ascertain change indicating cessation of 3:2 pull-down treatment of the signal being evaluated. Typically, luma data (black-and-white video data) or a portion of luma data is compared field-to-field. Other data may be compared, such as chrome data (color video data), a portion of chroma data or a combination of some or all of luma data and chroma data. As mentioned earlier herein, a problem is that there may be noise present in the signal being evaluated, and noise may give false values that are used in the field-to-field comparisons. Noise may be injected into the evaluated signal by conversion processes (i.e., from film to video; 3:2 pull-down treatment), from transmission operations via cable or satellite, or from other noise sources. Further, the prior art approach uses a single threshold for comparisons to ascertain change indicating cessation of 3:2 pull-down treatment. Noise may look like a change, but is not really a change that should indicate a cessation of 3:2 pull-down treatment. Noise can give false results using the prior art approach to detecting an end of 3:2 pull-down treated signals.

If an incorrect or erroneous detection of an exit from film-mode occurs then the system evaluating the video signal will exit film-mode or “unlock” film-mode and the video signal will thereafter be assembled incorrectly causing the video display to degrade. Noise is generally a short term condition, so the system evaluating the video signal will likely shortly realize the mistaken unlock (usually within the span of a couple of fields or so) and switch back to film-mode (“relock”). However, a viewer of the display will be able to see the degradation during the incorrect unlock condition. An observer will likely observe a discontinuity when the system executes the erroneous unlock, when the system executes the relock or on both occasions.

The invention provides a method and apparatus for improved detection of a video signal changing from film-mode so that such erroneous unlock and relock occasions may be reduced.

The invention compares a measurable feature of a field as the feature changes from field to field. Preferably the invention counts the number of luma pixels that change from one field to following field. It is preferred that measurements be measured in analog values to actually compare respective pixel values from successive fields with predetermined threshold values. If the difference between a pixel value and a predetermined threshold value is less than a predetermined amount, then it is preferred that the difference is ignored. It is preferred that the algorithm seek significant differences or significant field-to-field changes in pixel values.

It is preferred that each respective threshold value against which respective pixel values are compared are calculated in a manner relating each respective threshold value with pixel values in preceding fields. Pixel values may change from field to field. It is for this reason that the invention avoids comparing pixel values with a fixed threshold. A preferred threshold value is calculated as an average of pixel values over a number of previously occurring fields. Pixel values do change, as mentioned, but changes are not abrupt, so averaging pixel values over previously occurring fields serves to assure that the present threshold used for comparing with a concurrently presented pixel for evaluation will yield a realistic and timely indication of change in pixel value.

The invention may be implemented in software or in hardware. Hardware is generally faster implementation so that one may evaluate all pixels in a field in determining status of the video signal. Software is generally a slower implementation and may require that a sampling of less than all pixels be employed for field-to-field comparisons. In such a sampling environment (as compared with the all-pixel evaluation environment) one may wish to adjust threshold levels to accommodate the less-than-all sampling relied upon.

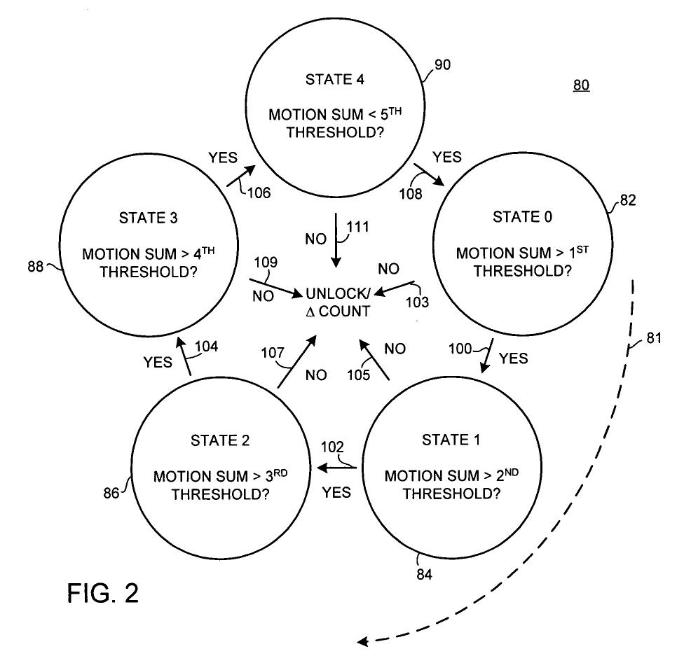

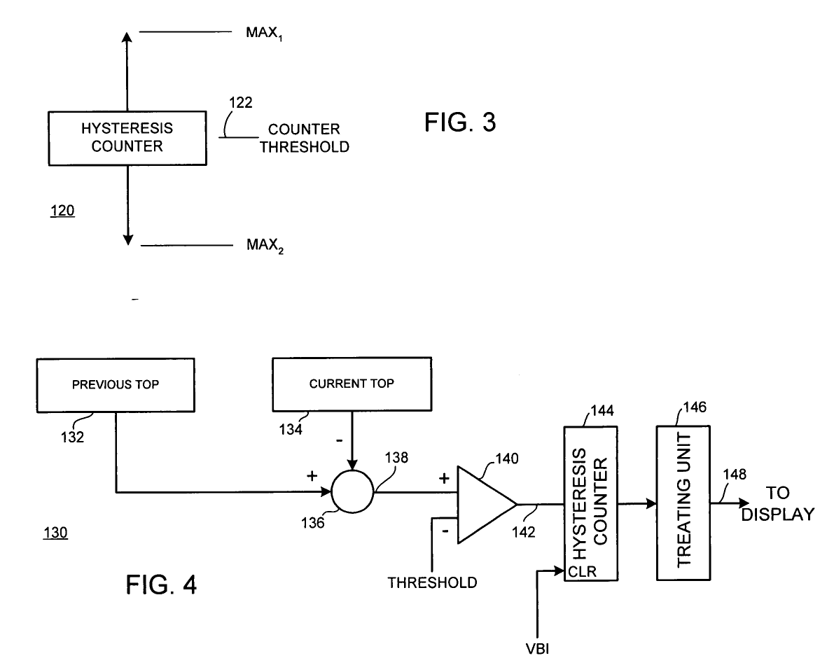

FIG. 2 is a schematic diagram of the state machine preferred for use in practicing the method of the present invention. In FIG. 2, a state machine initiates an evaluation at a State 0, indicated by a circular block 82. The State 0 evaluation inquires whether the motion sum currently evaluated is greater than a first threshold. If the motion sum currently evaluated is greater than the first threshold, state machine 80 proceeds in a clockwise direction 81 via a YES response path 100 to a State 1, indicated by a circular block 84, to evaluate a next motion sum. If the motion sum currently evaluated is not greater than the first threshold, state machine 80 proceeds via a NO response path 103 and the signal is unlocked (i.e., exits film-mode) or the count is changed in a hysteresis counter (see FIG. 3).

The State 1 evaluation inquires whether the motion sum currently evaluated is greater than a second threshold. If the motion sum currently evaluated is greater than the second threshold, state machine 80 proceeds in a clockwise direction 81 via a YES response path 102 to a State 2, indicated by a circular block 86, to evaluate a next motion sum. If the motion sum currently evaluated is not greater than the second threshold, state machine 80 proceeds via a NO response path 105 and the signal is unlocked (i.e., exits film-mode) or the count is changed in a hysteresis counter (see FIG. 3).

The State 2 evaluation inquires whether the motion sum currently evaluated is greater than a third threshold. If the motion sum currently evaluated is greater than the third threshold, state machine 80 proceeds in a clockwise direction 81 via a YES response path 104 to a State 3, indicated by a circular block 88, to evaluate a next motion sum. If the motion sum currently evaluated is not greater than the third threshold, state machine 80 proceeds via a NO response path 107 and the signal is unlocked (i.e., exits film-mode) or the count is changed in a hysteresis counter (see FIG. 3).

The State 3 evaluation inquires whether the motion sum currently evaluated is greater than a third threshold. If the motion sum currently evaluated is greater than the fourth threshold, state machine 80 proceeds in a clockwise direction 81 via a YES response path 106 to a State 4, indicated by a circular block 90, to evaluate a next motion sum. If the motion sum currently evaluated is not greater than the fourth threshold, state machine 80 proceeds via a NO response path 109 and the signal is unlocked (i.e., exits film-mode) or the count is changed in a hysteresis counter (see FIG. 3).

The State 4 evaluation inquires whether the motion sum currently evaluated is greater than a fifth threshold. If the motion sum currently evaluated is greater than the fifth threshold, state machine 80 proceeds in a clockwise direction 81 via a YES response path 108 to return to State 0 (circular block 82) to evaluate a next motion sum. If the motion sum currently evaluated is not greater than the fifth threshold, state machine 80 proceeds via a NO response path 111 and the signal is unlocked (i.e., exits film-mode) or the count is changed in a hysteresis counter (see FIG. 3).

The various thresholds employed in the various inquiries posed by State 0, State 1, State 2, State 3, State 4 are selected to effect checking for the characteristic film-mode HHHHL Cadence. The various thresholds are dynamically related with earlier-appearing fields, as described earlier herein, to assure accurate determination of pixel values and accurate evaluation of presence of the HHHHL Cadence.

If noise or something else interferes with the various evaluations performed by state machine 80, state machine 80 preferably continues in synchrony with a clocking signal so that state machine 80 continues to be timely poised for evaluating a field in its order of appearance. In such manner, one may be assured of properly evaluating a correctly timed field in its order. In such an event of loss of signal or interference with signal, thresholds may be employed without change until later occurring previous-field data may be employed to resume updating thresholds. In the alternative, a trend based upon recent threshold level changes may be stored and predicted so that a predicted threshold value may be employed with each state-inquiry as the state machine clock proceeds. As will be explained in greater detail in connection with FIG. 3, misses or “NO” responses by the various states during a signal loss or noise interference will cause a count in a hysteresis counter to change. When enough count changes occur, the hysteresis counter (FIG. 3) will indicate that the video signal being evaluated has changed from film-mode and state machine 80 will take one of the NO response lines 103, 105, 107, 109, 111 as appropriate to exit film-mode (i.e., to unlock).

FIG. 3 is a schematic diagram of the hysteresis counter unit preferred for use in practicing the method of the present invention. In FIG. 3, a hysteresis counter 120 is configured to count events in two directions, up-count toward a maximum MAX₁, and down-count toward a maximum MAX₂. A counter threshold 122 is established between maximums MAX₁, MAX₂. Counter 120 operates in response to a counting mechanism, such as state machine 80 (FIG. 2) to advance up-count toward maximum MAX₁ with each YES response to a state query, as manifested by state machine 80 proceeding via one of YES response lines 100, 102, 104, 106, 108. The maximum up-count is maximum MAX₁. The counting mechanism, such as state machine 80 will advance down-count toward maximum MAX₂ with each NO response to a state query, as manifested by state machine 80 proceeding via one of NO response lines 103, 105, 107, 109, 111. Whenever counter 122 crosses counter threshold 122 going toward maximum MAX₂, counter 120 will cause the system evaluating the video signal to unlock, or exit film-mode. Whenever counter 122 crosses counter threshold 122 going toward maximum MAX₁, counter 120 will cause the system evaluating the video signal to lock, or enter film-mode. Using a hysteresis counter unit such as counter 120 avoids the system evaluating a video signal “thrashing” about a threshold, and provides stability to the evaluating system as well as to the display of the video signal.

As mentioned earlier herein, if noise or something else interferes with the various evaluations performed by state machine 80 (FIG. 2), state machine 80 may continue in synchrony with a clocking signal so that state machine 80 continues to be timely poised for evaluating a video field in its order of appearance so as to properly evaluate a correctly timed field in its order. Misses or “NO” responses by the various states 82, 84, 86, 88, 90 during a signal loss or noise interference will cause a count in hysteresis counter 120 to change. When enough count changes occur in an appropriate direction to cross threshold 122 moving toward maximum MAX₂, hysteresis counter 120 will indicate that the video signal being evaluated has changed from film-mode and state machine 80 will take one of the NO response lines 103, 105, 107, 109, 111 as appropriate to exit film-mode (i.e., to unlock). When enough count changes occur in an appropriate direction to cross threshold 122 moving toward maximum MAX₁, hysteresis counter 120 will indicate that the video signal being evaluated has changed to film-mode and state machine 80 will take one of the YES response lines 100, 102, 104, 106, 108 as appropriate to enter film-mode (i.e., to lock).

FIG. 4 is an electrical schematic diagram of a preferred embodiment of the apparatus of the present invention. In FIG. 4, an apparatus 130 is configured for employing a previous top value 132 with a current top value 134 at a summing node 136 for presenting a motion sum at an output locus 138 of summing node 136. The motion sum is compared with a threshold in a comparing unit 140 and a count indicator is presented at an output locus 142 of comparing unit 140. The count indicator may, by way of example and not by way of limitation, be a “1” indicating a YES response to a state query, as manifested by state machine 80 (FIG. 2) proceeding via one of YES response lines 100, 102, 104, 106, 108; or the count indicator may be a “0” indicating a NO response to a state query, as manifested by state machine 80 proceeding via one of NO response lines 103, 105, 107, 109, 111.

It is preferred that the threshold employed for comparison in comparing unit 140 be related with earlier-appearing fields, as described earlier herein in connection with FIG. 2.

A hysteresis counter 144 receives the count indicator from comparing unit 140 and presents an indicator signal to a treating unit 146 that is indicative of the count present in counter 144, substantially as described earlier herein in connection with FIG. 3. Treating unit 146 responds to the indicator signal received from counter 144 to lock or unlock the video signal being evaluated, as appropriate. An output signal presented at an output locus 148 by treating unit 146 drives a display unit (not shown in FIG. 4) appropriately for the content of the video signal being evaluated. Similar comparison of previous bottom values with current bottom values are also carried out using a similar arrangement with a summing node. The structure for effecting such bottom value comparisons is omitted from FIG. 4 in the interest of simplicity. Such a structure may be provided with a separate summing node in parallel with elements 132, 134, 136 in FIG. 4. In the alternative, previous bottom values and current bottom values may be combined in summing node 136 in a time-sharing arrangement with elements 132, 134.

As indicated in FIG. 4, hysteresis counter 144 may be provided with a VBI (Vertical Blank Indicator) signal at an input node CLR to enable clearing contents of counter 140 So as to begin a new scan of a display.

It is to be understood that, while the detailed drawings and specific examples given describe preferred embodiments of the invention, they are for the purpose of illustration only, that the apparatus and method of the invention are not limited to the precise details and conditions disclosed and that various changes may be made therein without departing from the spirit of the invention which is defined by the following claims:

I claim:

1. A method for detecting change in a video stream from a film mode content; said video stream including a plurality of consecutively occurring video fields; each respective video field of said plurality of video fields contributing to a plurality of consecutively occurring motion sums; the method comprising:
(a) observing selected motion sums of said plurality of motion sums to detect a cadence of said motion sums characteristic of said film mode content; said cadence involving a pattern of said motion sums presented in repeated sets of said motion sums;
(b) comparing each respective motion sum in an extant said set with at least one extant motion sum threshold value; said at least one extant motion sum threshold value being related with at least one earlier-occurring said motion sum; and
(c) effecting said detecting when said comparing establishes that a respective said motion sum differs from said at least one extant motion sum threshold by a predetermined difference amount.

2. A method for detecting change in a video stream from a film mode content as recited in claim 1 wherein said detecting is effected when a count in a counter unit crosses a predetermined counter threshold in a predetermined direction; said count having one value of a positive value and a negative value when said respective motion sum is less than said at least one extant motion sum threshold; said count having another value than said one, value when said respective motion sum is greater than said at least one extant motion sum threshold.

3. A method for detecting change in a video stream from a film mode content as recited in claim 1 wherein said video stream is treated to effect a reversal of a pull-down conversion of said video signal when said count differs from a count trigger value by one amount of a positive amount and a negative amount, and wherein said video stream is not treated to effect a reversal of a pull-down conversion when said count differs from said count trigger value by another amount than said one amount.

4. A method for detecting change in a video stream from a film mode content as recited in claim 3 wherein said observing is effected using a clocked state machine; said clocked state machine responding to each said respective comparing by continuing said comparing with a next respective motion sum when said count differs from said count trigger value by said one amount.

5. A method for detecting change in a video stream from a film mode content as recited in claim 1 wherein said at least one extant motion sum threshold value is one extant motion sum threshold value.

6. A method for detecting change in a video stream from a film mode content as recited in claim 2 wherein said at least one extant motion sum threshold value is one extant motion sum threshold value.

7. A method for treating a video signal; said video signal including a plurality of consecutive video fields; first selected video fields of said plurality of video fields including film mode content; second selected video fields of said plurality of video fields including non-film mode content; at least some video fields of said plurality of video fields contributing to a plurality of substantially successively occurring motion sums; the method comprising:
(a) effecting successive comparison of selected motion sums of said plurality of motion sums with at least one motion sum threshold in a predetermined cycle; said at least one motion sum threshold having a value related with at least one earlier-occurring motion sum; said predetermined cycle establishing said successive comparison for evaluating whether said selected motion sums occur in a pattern characteristic of said film mode content;
(b) treating said video signal as containing said film mode content so long as said successive comparison indicates said video signal contains said film mode content; and
(c) treating said video signal as not containing said film mode content when a predetermined number of said successive comparisons indicate said video signal does not contain said film mode content.

8. A method for treating a video signal as recited in claim 7 wherein said successive comparison is carried out using a clocked state machine; said clocked state machine responding to each said respective comparing by continuing said comparing with a next respective motion sum when said count differs from a count trigger value by one amount of a positive amount and a negative amount.

9. A method for treating a video signal as recited in claim 7 wherein said indicating whether said video signal contains said film mode content is effected when a count in a counter unit crosses a predetermined counter threshold; said count having one value of a positive value and a negative value when said respective motion sum is less than said at least one motion sum threshold; said count having another value than said one value when said respective motion sum is greater than said at least one motion sum threshold.

10. A method for treating a video signal as recited in claim 9 wherein a reversal of a pull-down conversion of said video signal is effected when said count differs from a count trigger value by one amount of a positive amount and a negative amount, and wherein said reversal of said pull-down conversion of said video signal is not effected when said count differs from said count trigger value by another amount than said one amount.

11. A method for treating a video signal as recited in claim 8 wherein said indicating whether said video signal contains said film mode content is effected when a count in a counter unit crosses a predetermined counter threshold in a predetermined direction; said count having one value of a positive value and a negative value when said respective motion sum is less than said at least one motion sum threshold; said count having another value than said one value when said respective motion sum is greater than said at least one motion sum threshold.

12. A method for treating a video signal as recited in claim 11 wherein a reversal of a pull-down conversion of said video signal is effected when said count differs from a count trigger value by one amount of a positive amount and a negative amount, and wherein said reversal of said pull-down conversion of said video signal is not effected when said count differs from said count trigger value by another amount than said one amount.

13. A method for treating a video signal as recited in claim 7 wherein said at least one motion sum threshold is one motion sum threshold.

14. A method for treating a video signal as recited in claim 10 wherein said at least one motion sum threshold is one motion sum threshold.

15. A method for treating a video signal as recited in claim 12 wherein said at least one motion sum threshold is one motion sum threshold.

16. An apparatus for treating a video signal; said video signal including a plurality of consecutive video fields; first selected video fields of said plurality of video fields including film mode content; second selected video fields of said plurality of video fields including non-film mode content; at least some video fields of said plurality of video fields contributing to a plurality of substantially successively occurring motion sums; the apparatus comprising:
(a) a comparing unit for effecting successive comparison of selected motion sums of said plurality of motion sums with at least one motion sum threshold in a predetermined cycle; said at least one motion sum threshold having a value related with at least one earlier-occurring motion sum; said predetermined cycle establishing said successive comparison for evaluating whether said selected motion sums occur in a pattern characteristic of said film mode content; and
(b) a treating unit for coupled with said comparing unit; said treating unit treating said video signal as containing said film mode content so long as said successive comparison indicates said video signal contains said film mode content; said treating unit treating said video signal as not containing said film mode content when a predetermined number of said successive comparisons indicate said video signal does not contain said film mode content.

17. An apparatus for treating a video signal as recited in claim 16 wherein said successive comparison is carried out using a clocked state machine; said clocked state machine responding to each said respective comparing by continuing said comparing with a next respective motion sum when said count differs from a count trigger value by one amount of a positive amount and a negative amount.

18. An apparatus for treating a video signal as recited in claim 16 wherein the apparatus further comprises a counter unit coupled with said comparing unit; said indicating whether said video signal contains said film mode content being effected when a count in said counter unit crosses a predetermined counter threshold in a predetermined direction; said count having one value of a positive value and a negative value when said respective motion sum is less than said at least one motion sum threshold; said count having another value than said one value when said respective motion sum is greater than said at least one motion sum threshold.

19. An apparatus for treating a video signal as recited in claim 18 wherein a reversal of a pull-down conversion of said video signal is effected when said count differs from a count trigger value by one amount of a positive amount and a negative amount, and wherein said reversal of said pull-down conversion of said video signal is not effected when said count differs from said count trigger value by another amount than said one amount.

20. An apparatus for treating a video signal as recited in claim 17 wherein the apparatus further comprises a counter unit coupled with said comparing unit; said indicating whether said video signal contains said film mode content being effected when a count in said counter unit crosses a predetermined counter threshold in a predetermined direction; said count having said one value of a positive value and a negative value when said respective motion sum is less than said at least one motion sum threshold; said count having another value than said one value when said respective motion sum is greater than said at least one motion sum threshold; a reversal of a pull-down conversion of said video signal being effected when said count differs from a count trigger value by one amount of a positive amount and a negative amount; said reversal of said pull-down conversion of said video signal not being effected when said count differs from said count trigger value by another amount than said one amount.
